(19) United States
(12) Patent Application Publication
(10) Pub. No.: US 2026/0145189 A1
(43) Pub. Date: May 28, 2026

(54) POWDER DELIVERY SYSTEM OF A POWDER COATING INJECTOR BASED ON THE VENTURI PRINCIPLE

(71) Applicant: SISTEM TEKNIK MAKINA SANAYI VE TICARET ANONIM SIRKETI, Konak, Izmir (TR)

(72) Inventors: Deniz TÜRKÜN, Menderes, Izmir (TR); Serdar KAYA, Menderes, Izmir (TR); Asejan ÖZDEN, Menderes, Izmir (TR); Arda HEPÇETINER, Menderes, Izmir (TR)

(21) Appl. No.: 19/123,444

(22) PCT Filed: Jun. 6, 2024
(86) PCT No.: PCT/TR2024/050615

§ 371 Date: Apr. 23, 2025

(30) Foreign Application Priority Data
Jun. 7, 2023 (TR) 2023/006605

(51) Int. Cl. B05B 7/14

(52) U.S. Cl. CPC B05B 7/1472

(57) ABSTRACT

Disclosed is a coating injector, the parts of the powder delivery system of which are removable. The parts of the powder delivery system, namely, the hose fitting, the nozzle and the bushing, can be assembled and disassembled by rotation.

### TECHNOLOGICAL FIELD

The present invention relates to powder paint injectors for transferring powder paint sucked from a tank or reservoir under vacuum to a powder paint gun.

The present invention relates to a powder delivery system in powder paint injectors.

### STATE OF THE ART

The vacuum environment required for the suction of the powder paint is obtained by the venturi principle. In the Venturi principle, when the fluid moving at high speed and in a narrow cross-section with vacuum power is directed first to a narrow and then to a wide cross-section, negative pressure occurs in the narrowest region. This negative pressure acts as a drive for the transfer of substances. The pressurised fluid in powder paint injectors is air. The material vacuumed and transferred is powder paint.

Powder paint injectors used in the industry, based on the venturi principle; generally suck the powder paint from a reservoir through a channel or a pipe or a hose by means of a vacuum force created by the venturi effect inside the injector. In powder paint injectors, the way in which the air is sent to the nozzle that creates the venturi effect is called the main air, and the air that supports the progress of the sucked paint in the powder paint hose is called auxiliary air.

Powder paint injectors are connected to devices that manage the air flow rate and/or pressure. Generally, from these devices, main air is sent to the nozzle area for venturi effect and auxiliary air is sent to ensure the progress of the powder paint in the device. Changing the amount of main and auxiliary air in the device causes more or less paint air mixture to be sent to the powder spray gun to which the injector is connected by a hose. In this way, the powder paint-air ratio in the application is provided at the desired level.

In the known art, the parts in the powder paint injector powder paint delivery path do not have a modular design. The lack of an interlocking powder delivery system by rotation or similar causes disruptions and time losses in the production and cleaning of the powder paint injector. At the same time, if a part of the powder delivery system fails, the entire powder delivery system must be replaced, this increases maintenance costs.

The patent document numbered EP0718047B1 encountered in the literature search is related to a powder paint injector. The document describes an air injector for the powder feeder in a powder paint system with a powder barrier with a filter element made of microporous material. The powder delivery system of the mentioned document does not have a modular design. For this reason, when one of the parts of the powder delivery system fails, the entire powder delivery system must be replaced.

The patent document U.S. Pat. No. 11,446,683B2, which was encountered in the literature search, mentions a nozzle assembly structure consisting of an inseparably connected nozzle and a bushing combined with the nozzle. When the nozzle assembly is to be removed from the body, it is removed from the injector body only as a unified assembly, since the nozzle assembly is a single unified structure. This method, in which the nozzle and bushing in the spring are combined, is a costly solution as both products must be replaced together when any maintenance is required in the relevant parts.

The patent document numbered U.S. Pat. No. 9,636,695, which was encountered in the literature search, is related to the powder paint injector based on the venturi principle. In the injector described in the document, since the elements of the powder delivery system are not removable, the entire system must be replaced in case of failure of the parts in the powder delivery system.

The major disadvantage of powder paint injectors in the known art is that the parts that make up the powder delivery system are not removable. Therefore if a part of the powder delivery system fails, the entire powder delivery system must be replaced.

As a result, there is a need for a new powder paint injector in which the known state of the art is overcome and its disadvantages are eliminated.

### BRIEF DESCRIPTION OF THE INVENTION

The invention is a powder paint injector which exceeds the state of the art, eliminates the disadvantages and has some additional features.

The object of the invention is to provide a new powder paint injector, the powder delivery system parts of which are removable.

A further object of the invention is to provide a new powder paint injector which reduces maintenance costs in the event of malfunctions in the powder delivery system.

A further object of the invention is to provide a new powder paint injector in which the parts of the powder delivery system can be rotatably assembled and disassembled.

### DESCRIPTION OF THE FIGURES

The present invention will be described with reference to the accompanying drawings, thus the characteristics of the invention will be understood clearly. However, the aim of this is not to limit the invention with such certain embodiments. On the contrary, it is aimed to cover all alternatives, amendments and equivalents which may be contained in the field defined by the accompanying claims. It is to be understood that the details shown are only shown for the sake of illustrating the preferred embodiments of the present invention and presented for both illustrating the methods and for providing description of the rules of the invention and the conceptual features of the invention to be easily understood. In these figures;

FIG.-1 View showing the general working principle of the powder paint injector of the present invention.

FIG.-2a View showing the assembly of the injector system into the injector housing.

FIG.-2b View expressing that the powder paint injector subject to the invention can be easily disassembled with the help of the protrusion that facilitates its connection with human hands during the assembly of the injector system into the injector housing.

FIG.-3 Cross-sectional view of the powder paint injector of the present invention.

FIG.-4a Cross-sectional view of the powder delivery system used in the powder paint injector of the present invention.

FIG.-4b Exploded assembly view of the powder delivery system used in the powder paint injector of the invention.

FIG.-5 Exploded cross-sectional view of the powder paint injector of the present invention.

FIG.-6a View showing that the circular shaped clamping part on the powder paint injector subject to the invention can be removed by turning the same counter clockwise.

FIG.-6b View showing that the powder delivery system shown on the powder paint injector subject to the invention can be rotated in the direction of the arrow shown at an angle of approximately 60°.

FIG.-6c View showing the movement of the hose fitting in the powder paint injector subject to the invention, which is released by the rotational movement of the hose fitting and can come out of the injector body and the nozzle remains in the injector body.

FIG.-6d A view showing the hose fitting in the powder paint injector subject to the invention being attached to the body of the powder paint injector and rotating anti-clockwise at an angle of about 60°, as indicated by the arrow.

FIG.-6e View showing the removal of the hose fitting and nozzle of the powder paint injector subject to the invention from the injector body by clamping each other.

FIG.-7a Perspective view of the nozzle in the powder delivery system from the rear diagonal.

FIG.-7b Perspective view of the nozzle in the powder delivery system from the front diagonal.

FIG.-8a Perspective view of the hose fitting in the powder delivery system from the rear left diagonal.

FIG.-8b Perspective view of the hose fitting in the powder delivery system from the rear right diagonal.

FIG.-9 Sectional view of the bushing in the powder delivery system.

The figures which enable to clarify this invention are enumerated as mentioned in the attached figure and they are given with their names herein below.

### DESCRIPTION OF THE REFERENCES

1. Powder paint injector
10. Injector body
   101. Injector paint inlet path
   102. Injector body delivery path
      1021. Injector body delivery path axis
   103. Injector body gripping protrusion
11. Circular shaped clamping part
   111. Clamping part engagement section
   112. Engagement section
   113. Powder delivery system retaining protrusion
12. Filter system clamping part
20. Powder delivery system
21. Hose fitting
   211. Hose fitting locking thread
   212. Hose fitting airway inlet
   213. Hose fitting air delivery path
   214. Hose fitting bushing path
   215. Hose fitting holding protrusion
   216. Hose fitting circular section flexible part
22. Nozzle
   221. Nozzle air inlet path
   222. Venturi effect creative section
   223. Nozzle locking thread
   224. Nozzle anti-rotation recess
   225. Bushing seat gap
   226. Circular section flexible part front
   227. Circular section flexible part rear
23. Bushing
   231. Bushing circular section flexible part
      2311. Bushing circular section flexible part housing
   232. Bushing seat protrusion
30. Filter system
   A. Main air filter system path
   A1. Main air
   A. Auxiliary air filter system path
   B1. Auxiliary air
   C. Powder paint delivery system path
   D. Powder paint suction path
   E. Powder paint device
   F. Chamber
   F1. Powder paint
   F2. Powder paint gun
   F3. Powder paint hose
   F4. Injector housing
   G. Human hand
   G1. Finger

### DESCRIPTION OF THE INVENTION

In this detailed description, the inventive powder paint injector (1) is described by means of examples only for clarifying the subject matter such that no limiting effect is created.

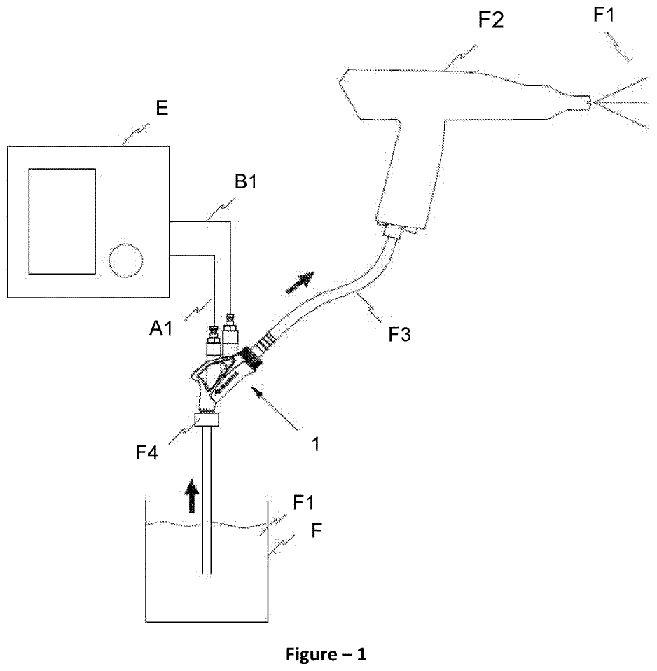

FIG. 1 shows a view explaining the intended use of the powder paint injector (1) of the present invention. Accordingly, the powder paint injector (1) takes the powder paint (F1) in a chamber (F) and transfers the same to the powder paint gun (F2) via the powder paint hose (F3). The connection of the powder paint injector (1) to the chamber (F) is provided by the injector housing (F4). In the invention, powder paint (F1) is defined as a kind of special chemical substance in powder form that is used for coating purposes in various applications. Powder paint gun (F2) is the tool that enables the application of powder paint (F1). The powder paint injector (1) subject to the invention works on the venturi principle. As it is known, main air (A1) and auxiliary air (B1) are used in powder paint injectors (1) that work with the venturi principle. The main air (A1) ensures that the powder paint (F1) is sucked from the chamber (F) and sent to the powder paint gun (F2) with the effect of the venturi. Auxiliary air (B1) provides support in delivering the powder paint-air mixture created in the powder paint injector (1) based on the venturi principle to the powder paint gun (F2). In other words, while the main air (A1) draws powder paint (F1) from the chamber (F), the amount of powder paint (F1) desired to be transferred to the powder paint gun (F2) is determined by the auxiliary air (B1). By changing the amounts of main air (A1) and auxiliary air (B1), the amount of powder paint (F1) transferred to the powder paint gun (F2) can be increased or decreased. In the invention, main air (A1) is supplied to the main air filter system path (A) in the powder paint injector (1), and auxiliary air (B1) is supplied to the auxiliary air filter system path (B). The supply of main air (A1) and auxiliary air (B1) is provided by the powder paint device (E). The powder paint device (E) is a control device, which ensures that the main air (A1) and auxiliary air (B1) are sent to the powder paint injector (1) at the desired rate. Main air (A1) and auxiliary air (B1) are passed through the filter system (30) fixed to the injector body (10) with the filter system clamping part (12).

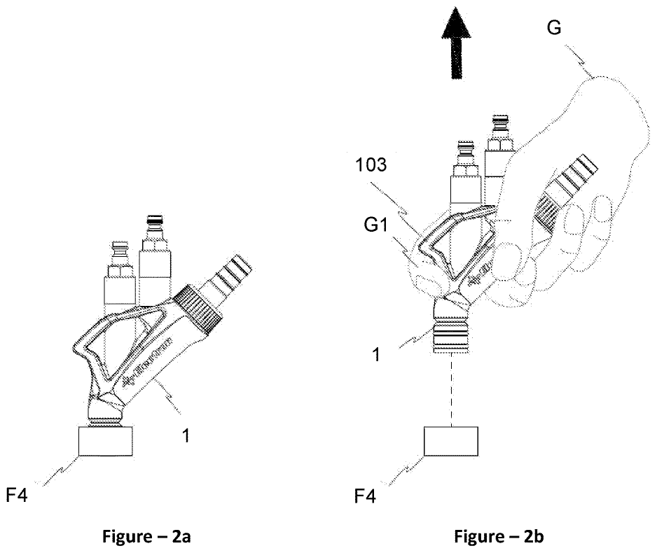

FIG. 2a and FIG. 2b show the view showing the separation of the powder paint injector (1) subject to the invention from the injector housing (F4), which provides its relationship with the chamber (F). Accordingly, the powder paint injector (1) comprises an injector body gripping protrusion (103) on the injector body (10), where the index finger (G1) of the human hand (G) is placed, which increases the gripping ability. When the powder paint injector (1) is grasped by the human hand (G) and pulled upwards, the injector is separated from its housing (F4).

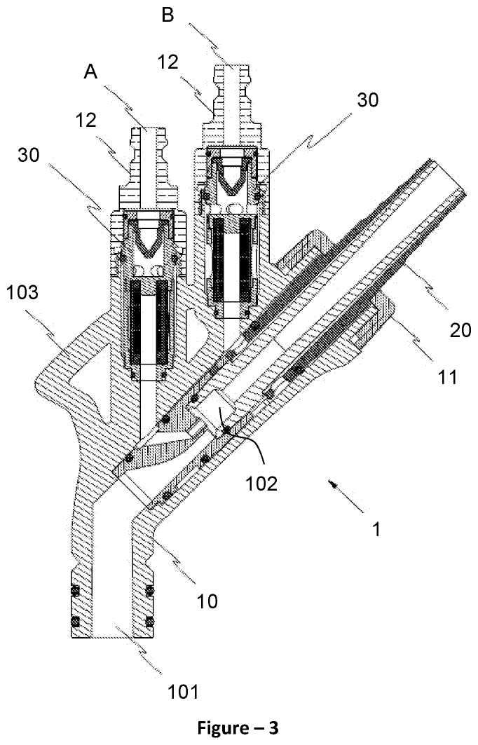

FIG. 3 shows a sectional view of the powder paint injector (1) subject to the invention. Accordingly, in the injector body (10) of the powder paint injector (1), the powder paint (F1) enters the injector paint inlet path (101) and travels along the injector body delivery path (102) in the direction of the injector body delivery path axis (1021). This section is referred to as the powder delivery system (20). The powder delivery system (20) is the part that comprises all the parts on the path that the powder paint (F1) and air mixture follows in the powder paint injector (1) until it is transferred to the powder paint hose (F3). It is mounted on the injector body (10) with a circular shaped clamping part (11). In the invention, a filter system (30) is used in the main air filter system path (A) and the auxiliary air filter system path (B).

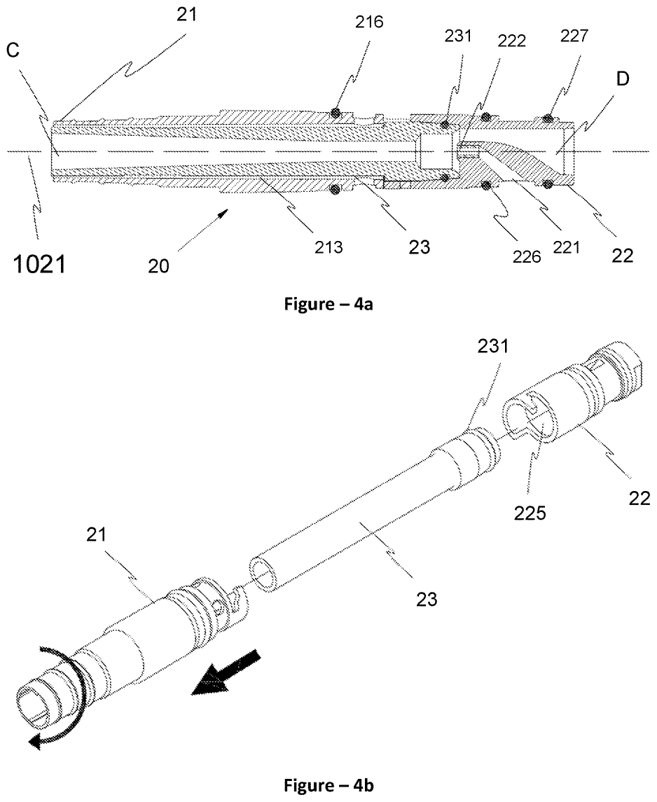

The distinguishing part of the powder paint injector (1) subject to the invention is the powder delivery system (20), and the feature of the powder delivery system (20) is that its parts can be detached and assembled. In this way, cleaning and maintenance processes are facilitated. FIG. 4a shows the cross-sectional view of the powder delivery system (30) in the powder paint injector (1) subject to the invention, and FIG. 4b shows its exploded view. The powder delivery system (30) consists of the hose fitting (21), nozzle (22) and bushing (23). In the powder paint suction path (D), the powder paint (F1) absorbed from the chamber (F) is transferred to the powder paint hose (F3) by proceeding through the powder paint delivery system path (C).

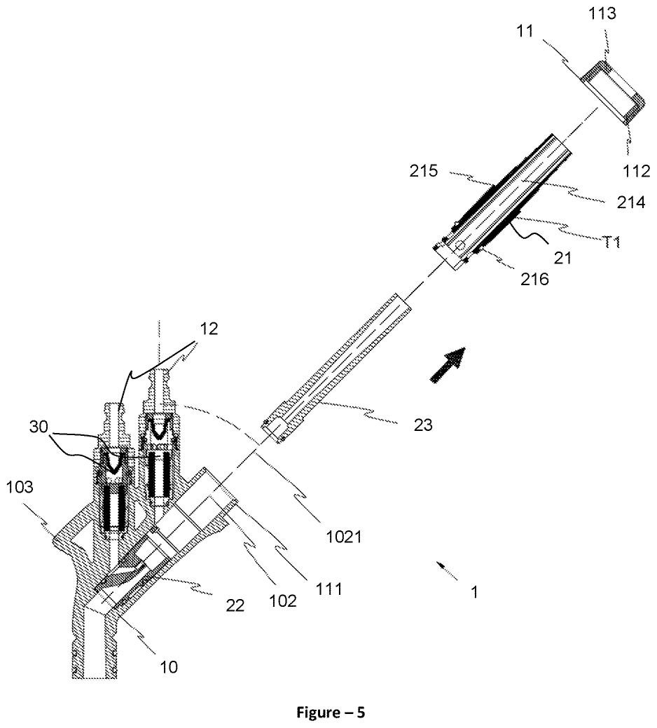

As seen in FIG. 5, the hose fitting (21), nozzle (22) and bushing (23), which are the elements of the powder delivery system (20), can fit into each other. These elements are fixed to the injector body (10) with a circular-shaped clamping part (11). The circular shaped clamping part (11) comprises an engagement section (112). The engagement section (112) is associated with the clamping part engagement section (111), which is the circular region in the injector body (10) where the circular shaped clamping part (11) will be rotated and compressed. The powder delivery system holding protrusion (113) located on the circular shaped clamping part (11) is a geometric element compatible with the hose fitting holding protrusion (215) located on the hose fitting (21).

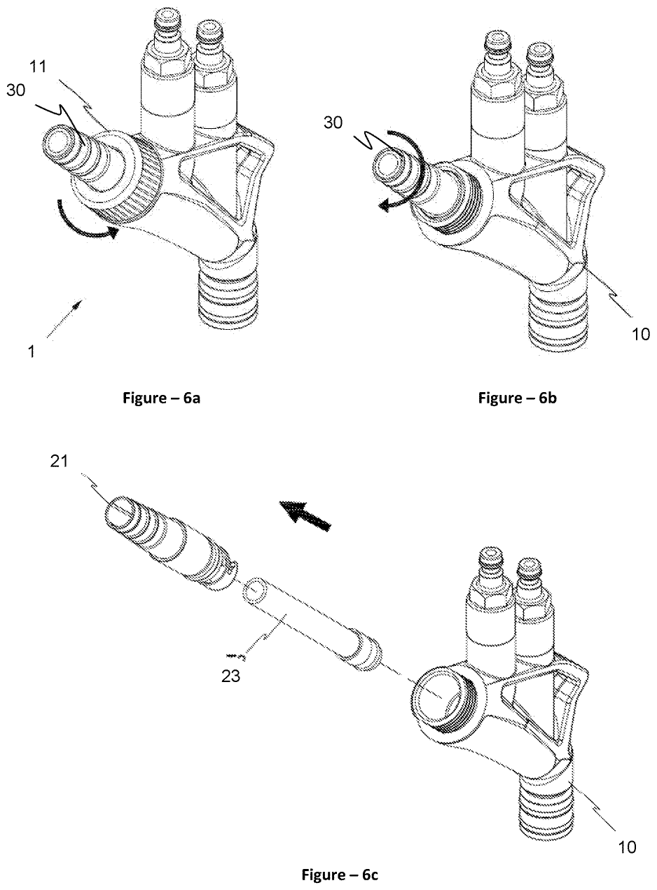

As seen in FIG. 6a, when the circular shaped clamping part (11) is removed by turning counter clockwise, the powder delivery system (20) is removed by turning clockwise. (FIG.-6b) With this movement, the hose fitting (21) and bushing (23) are separated from the nozzle (22) in the injector body (10). (FIG.-6c) When the powder delivery system (20) is disassembled by rotating counter clockwise, (FIG.-6d) the hose fitting (21) and nozzle (22) are clamped together and separated from the injector body (10) together. (FIG.-6e) Here, the rotation angle is 60° and this angle can vary according to the design. What is important here is that when rotated clockwise, the hose fitting (21) and bushing (23) are separated from the injector body (10), the nozzle (22) remains in the injector body (10), and when rotated anti-clockwise, the hose fitting (21) and nozzle (22) are clamped together and separated from the injector body (10) together.

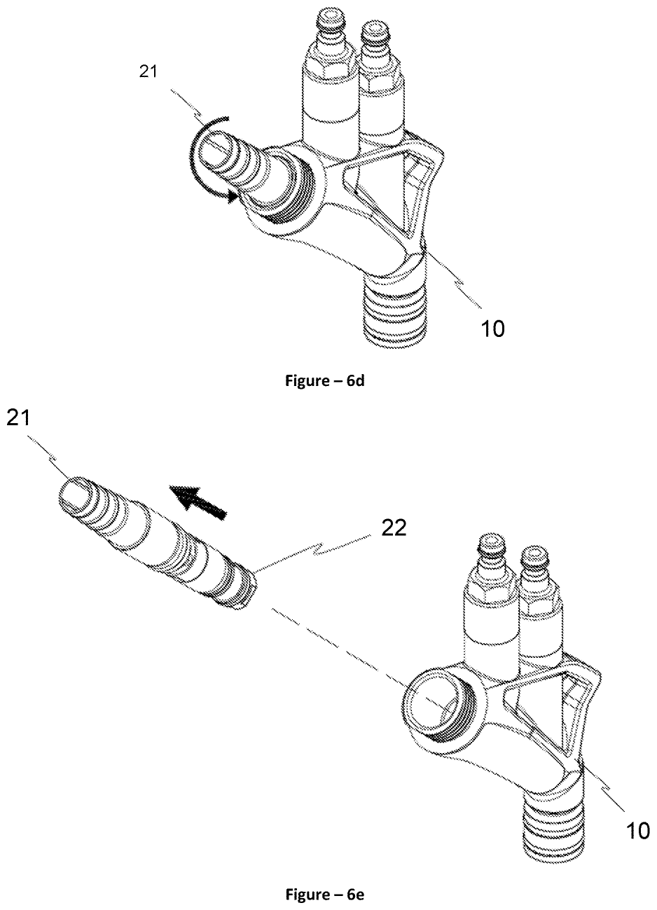

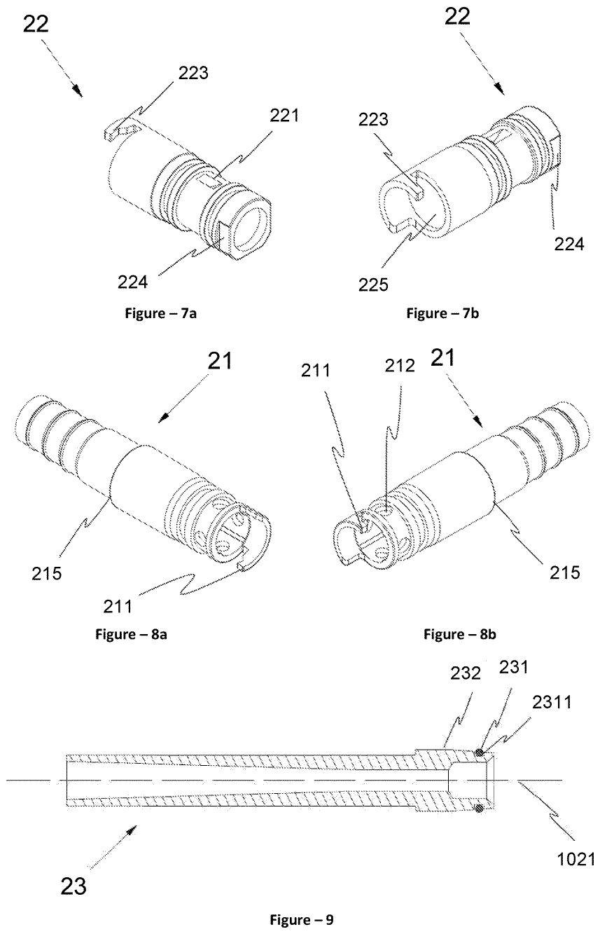

FIG. 7a and FIG. 7b show perspective views of the nozzle (22) used in the invention. The nozzle (22) used in the invention is the part where the venturi effect occurs, allowing the powder paint (F1) to be sucked from the chamber (F) into the powder delivery system (20). Inside the nozzle (22), there is the nozzle air inlet path (221), where the air enters, and the venturi effect creating section (222), which is on the same axis as the injector body delivery path axis (1021), which accelerates the air and creates the venturi effect. (FIG.-4a) The nozzle (22) subject to the invention is associated with the hose fitting (21). This relationship is ensured by the nozzle locking thread (223), which has an asymmetrical geometrical element, which is compatible with the hose fitting locking thread (211) in the nozzle (22), and which enables the nozzle (22) and the hose fitting (21) to be locked together by rotational movement. The relationship of the nozzle (22) to the bushing (23) is provided by the bushing seat gap (225) in the nozzle (22), into which the bushing seat protrusion (245) on the bushing (23) can be inserted. The nozzle (22) used in the invention further comprises a nozzle anti-rotation recess (224) which restricts the rotational movement of the nozzle (22). The nozzle anti-rotation recess (224) prevents the nozzle (22) from rotating in its seat in the injector body (10). The nozzle (22) further comprises a circular flexible part front (226) and a circular flexible part rear (227) for forming an airtight zone so that the main air (A1) from the filter system (30) can reach the nozzle air inlet path (221). The nozzle (22) has a sealing element at the front and rear. (FIG.-4a) The inventive hose fitting (21) shown in FIG. 8a and FIG. 8b is the part in the powder delivery system (20) through which the powder paint (F1) is transferred to the powder paint hose (F3). The auxiliary air (B1) enters the hose fitting air inlet path (212) and the hose fitting air delivery path (213) through which the air and powder paint (F1) move towards the powder paint hose (F3). The hose fitting (21) is associated with the nozzle (22) and bushing (23) in the powder delivery system (20). The hose fitting (21) is connected to the bushing seat protrusion (232) located on the bushing (23) via the hose fitting bushing path (214). The relationship between the hose fitting (21) and the nozzle (22) is provided by the hose fitting locking thread (211). In the 60° counter clockwise movement of the hose fitting (21), the hose fitting locking thread (211) engages the nozzle locking thread (223) and joins the nozzle (22) and the hose fitting (21). In the 60° clockwise movement of the hose fitting (21), the hose fitting locking thread (211) and nozzle locking thread (223) are separated from each other, and as a result, the nozzle (22) and hose fitting (21) are separated. The hose fitting (21) comprises a hose fitting holding protrusion (215) compatible with the powder delivery system holding protrusion (113) on the circular shaped clamping part (11). The hose fitting holding protrusion (215) ensures that the hose fitting (21) and therefore the powder delivery system (20) remains inside the injector body (10). The hose fitting (21) also has a circular section flexible part (216) of the hose fitting, which creates an airtight zone so that the auxiliary air (B1) passing through the filter system (30) can reach the hose fitting airway inlet (212).

The bushing (23) used in the powder delivery system (20) shown in FIG. 9 is a circular part that allows the delivery of powder paint (F1) by opening the high-speed air coming from the venturi effect creating section (222) first to a narrow section and then to a wide section. The relationship with the hose fitting (21) is provided by the bushing seat protrusion (232) that sits on the hose fitting bushing path (214). The bushing comprises a circular section flexible part (231) on the bushing (23), which provides air tightness between the bushing (23) and the nozzle (22) when mounted on the nozzle (22). The bushing circular section flexible part (231) is placed in the bushing circular section flexible part housing (2311).

In the powder paint injector (1) that is the subject of the invention, the hose fitting (21), nozzle (22) and bushing (23) that constitutes the powder delivery system (20) are independent parts from each other. It can be combined or separated by rotating it. In this way, convenience is provided during maintenance, repair, cleaning and parts replacement.

1. Powder delivery system in a powder paint injector which operates on the Venturi principle, the powder delivery system comprising at least one hose fitting, at least one nozzle and at least one bushing which can be rotatably joined or separated from each other.

2. A powder delivery system according to claim 1, characterized in that, it comprises the following; comprising:
at least one hose fitting locking thread on the at least one hose fitting, which engages a nozzle locking thread in clockwise rotation of the at least one hose fitting and disengages from the nozzle locking thread in anti-clockwise rotation;
at least one nozzle locking thread located on the at least one nozzle, which is associated with said hose fitting locking thread preceding step.

3. A powder delivery system according to claim 1, characterized in that, comprising:
at least one hose fitting bushing path for connecting the at least one hose fitting with a bushing seat protrusion in the at least one bushing;
the bushing seat protrusion having a geometrical structure compatible with a bushing seat gap, which enables the at least one bushing to be inserted into the at least one nozzle.

4. A powder delivery system according to claim 1, comprising a hose fitting air inlet path in the at least one hose fitting through which auxiliary air enters.

5. A powder delivery system according to claim 1, comprising a hose fitting air delivery path in the at least one hose fitting in which auxiliary air and powder paint travels towards the a powder paint hose.

6. A powder delivery system according to claim 1, comprising at least one hose fitting retaining protrusion on the at least one hose fitting compatible with a powder delivery system retaining protrusion on the circular formed clamping part.

7. A powder delivery system according to claim 1, comprising at least one hose fitting circular flexible part forming an airtight zone on the at least one hose fitting such that auxiliary air passing through the filter system can reach a hose fitting airway inlet.

8. A powder delivery system according to claim 1, comprising a Venturi effect creating section on the at least one nozzle, on the same axis with an nozzle air inlet path where the air enters and an injector body delivery path axis, which accelerates the air to create the Venturi effect.

9. A powder delivery system according to claim 1, comprising a nozzle anti-rotation recess on the at least one nozzle, which prevents the at least one nozzle from rotating in its housing within an injector body.

10. A powder delivery system according to claim 1, comprising a circular flexible part front and a circular flexible part rear to form an airtight zone on the at least one nozzle so that main air from the filter system can reach a nozzle air inlet path.

11. A powder delivery system according to claim 1, comprising a circular section flexible part on the at least one bushing, which provides air tightness between the at least one bushing and the at least one nozzle when mounted on the at least one nozzle and the bushing on which it is placed is a circular section flexible part housing.

12. A method for a powder delivery system comprising a hose fitting and nozzle in a powder paint injector operating on the Venturi principle, the method comprising:
combining the nozzle and the hose fitting by interlocking a hose fitting locking thread with a nozzle locking thread, in a counter-clockwise movement of the hose fitting; and
separation of the hose fitting locking thread and the nozzle locking thread in the clockwise movement of the hose fitting.

13. A method according to claim 12, wherein the clockwise or anticlockwise rotational movement is 60°.
